(19) United States
(12) Patent Application Publication
(10) Pub. No.: US 2010/0175469 A1
(43) Pub. Date: Jul. 15, 2010

(54) Electrically heated fluid tube

(76) Inventor: Frank (Zhi) Ni, Dexter, MI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/319,669

(22) Filed: Jan. 9, 2009

(51) Int. Cl. G01F 1/69

(52) U.S. Cl. 73/204.27

(57) ABSTRACT

An electrically heated, flexible fluid conduit or tube (40) includes an elongate, flexible tube body (42) defining a fluid flow path L (44) having a length (L) extending along a longitudinal axis (46). The tube body (42) includes an electrical resistance heater (48) surrounding the fluid flow path (44) over the length (L). The electrical resistance heater (48) has a heat output per unit length per voltage applied that does not vary when the tube body (42) is cut to different lengths.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to fluid conduits and, more particularly, to flexible fluid conduits or tube that are heated electrically to prevent freezing of the fluid passing through the tube and/or to melt frozen fluid within the tube, and in more particular applications, to heated flexible fluid tubes that are utilized in urea injection systems for vehicular diesel exhaust gas treatment systems.

### BACKGROUND OF THE INVENTION

In fluid flow systems that experience cold weather conditions, it becomes important that the fluid supply conduits or tubes be heated so that the fluid flowing through the tubes does not become frozen during operation and/or so that fluid that has become frozen in the tubes during periods of nonoperation can be thawed so that the fluid can flow and the system can become operational. To address this concern, electrically heated fluid conduits or tubes are known and typically utilize heat generating resistant wires that extend along the length of the tube, with the heat output per voltage applied being highly dependent upon the length of the wire and tube, as well as the gauge and material of the resistance wires. For example, with a certain voltage, the resistance will increase with length of the wire and tube and the power output will decrease, but it is quite common to require a certain power output per unit length. Thus, while these have been known to work well for their intended purpose, such constructions require a new design and different final product for every different desired length of tubing. This can be problematic for any number of applications, one of which includes the tubes used to supply urea in a urea injection systems for diesel exhaust gas treatment systems in various vehicular applications, with each application potentially requiring a different length of tubing.

### SUMMARY OF THE INVENTION

In accordance with one feature of the invention, an electrically heated, flexible fluid tube includes an elongate, flexible tube body defining a fluid flow path extending along a longitudinal axis, a first electrical power conduit in the tube body extending along the longitudinal axis on one side of the flow path, a second electrical power conduit in the tube body extending along the longitudinal axis on a side of the flow path opposite from the one side, and heat generating electrical flow paths extending circumferentially in the tube body around the flow path and connecting the first and second power conduits to heat the flow path along the longitudinal axis.

As one feature, the heat generating electrical flow paths comprise a wire in the tube body wrapped around the fluid flow path, the wire engaging each of the power conduits at multiple points along the longitudinal axis.

According to one feature, the heat generating electrical flow paths comprise electrically conductive polymers within the tube body surrounding the fluid flow path.

In one feature, the fluid tube further includes a first electrical connection for the first electrical power conduit at an end of the tube, and a second electrical connection for the second electrical power conduit at an end of the tube. As a further feature, the first and second electrical connections are at the same end of the tube.

In accordance with one feature of the invention, an electrically heated, flexible fluid tube includes an elongate, flexible tube body defining a fluid flow path extending along a longitudinal axis, and heat generating electrical flow paths extending circumferentially in the tube body around the flow path transverse to the longitudinal axis.

As one feature, the fluid tube further includes: a first electrical power conduit in the tube body extending along the longitudinal axis on one side of the flow path; and a second electrical power conduit in the tube body extending along the longitudinal axis on a side of the flow path opposite from the one side. The first and second electrical power conduits are connected to the heat generating electrical flow paths to supply electric power thereto. In a further feature, the fluid tube further includes a first electrical connection for the first electrical power conduit at an end of the tube, and a second electrical connection for the second electrical power conduit at an end of the tube. In yet a further feature, the first and second electrical connections are at the same end of the tube.

According to one feature, the heat generating electrical flow paths comprise an electrically conductive wire in the tube body wrapped around the fluid flow path, the wire engaging each of the power conduits at multiple points along the longitudinal axis.

As one feature, the heat generating electrical flow paths comprise electrical conductive polymers within the tube body surrounding the fluid flow path.

In accordance with one feature of the invention, an electrically heated, flexible fluid tube includes an elongate, flexible tube body defining a fluid flow path having a length extending along a longitudinal axis. The tube body includes an electrical resistance heater surrounding the fluid flow path over the length, the electrical resistance heater having a heat output per unit length that does not vary when the tube body is cut to different lengths.

According to one feature, the fluid tube further includes: a first electrical power conduit in the tube body extending along the longitudinal axis on one side of the flow path, and a second electrical power conduit in the tube body extending along the longitudinal axis on a side of the flow path opposite from the one side. The first and second electrical power conduits contact the electrical resistance heater to supply electric power thereto. In a further feature, the fluid tube further includes a first electrical connection for the first electrical power conduit at an end of the tube, and a second electrical connection for the second electrical power conduit at an end of the tube. In yet a further feature, the first and second electrical connections are at the same end of the tube.

As one feature, the electrical resistance heater includes electrically conductive polymers within the tube body.

In one feature, the fluid tube further includes a first electrical power conduit in the tube body extending along the longitudinal axis on one side of the flow path, and a second electrical power conduit in the tube body extending along the longitudinal axis on a side of the flow path opposite from the one side. The first and second electrical power conduits contact the electrically conductive polymers to supply electric power thereto.

According to one feature, the electrical resistance heater further includes an electrically conductive wire in the tube body wrapped around the fluid flow path.

In one feature, the fluid tube further includes a first electrical power conduit in the tube body extending along the longitudinal axis on one side of the flow path, and a second electrical power conduit in the tube body extending along the longitudinal axis on a side of the flow path opposite from the one side. The first and second electrical power conduits contact the wire at multiple points along the longitudinal axis to supply electric power to the wire at each of the multiple points.

Other objects, features, and advantages of the invention will become apparent from a review of the entire specification, including the appended claims and drawings.

### BRIEF DESCRIPTION OF THE DRAWINGS

FIG. 1 is a diagrammatic view of an exhaust gas system including a heated tube embodying the present invention;

FIG. 2 is a somewhat diagrammatic, longitudinal section view of the heated tube of FIG. 1;

FIG. 3 is a transverse section view of the heated tube of FIG. 1 taken from line 3-3 in FIG. 2;

FIG. 4 is a diagrammatic modeling of a resistance heater of the heated tube of FIG. 1;

FIG. 5 is a somewhat diagrammatic view showing one embodiment of the heated tube of FIG. 1;

FIGS. 6 and 7 are longitudinal and transverse section views, respectively, of another embodiment of the heated tube of FIG. 1.

### DETAILED DESCRIPTION OF THE PREFERRED EMBODIMENTS

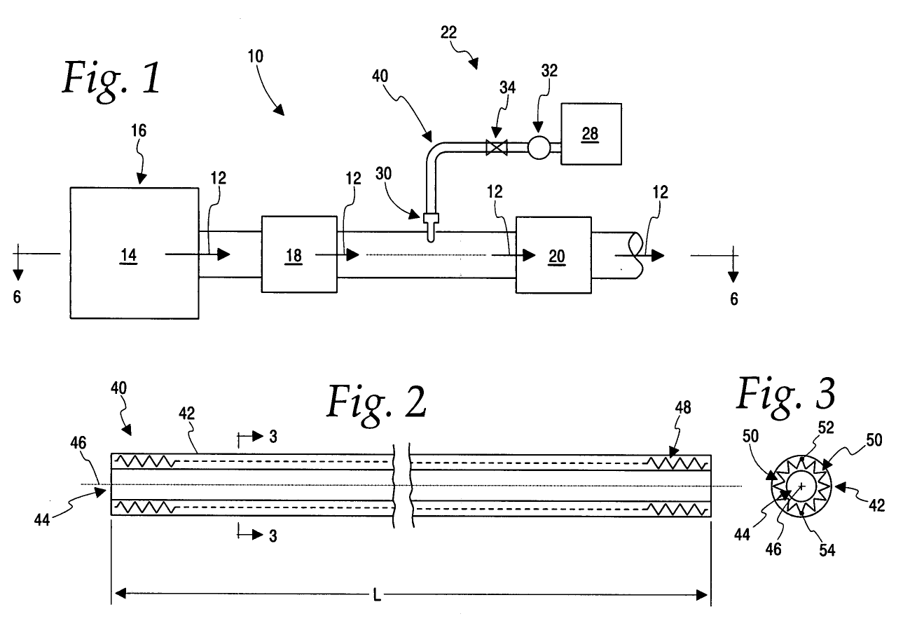

With reference to FIG. 1, a diesel exhaust gas after treatment system 10 provided to treat the exhaust 12 from a diesel combustion process 14, such as a diesel compression engine 16. The system 10 can include one or more exhaust gas treatment components 18 that clean and/or otherwise treat the exhaust gas 12, such as for example, a diesel particle filter (DPF), a burner, a diesel oxidation catalyst (DOC), a lean NOX trap, etc. There are many suitable types of constructions for such components, the selection of which will be highly dependent upon the parameters of each particular application.

The system 10 further includes a selective catalytic reduction catalyst (SCR) 20 and a urea injection system 22 for injecting urea 24 into the exhaust 12 upstream from the SCR 20. The urea injection system 22 will typically include a tank 28 or other type of container for the urea 24, one or more urea injectors 30, a pump 32 pressurizing the urea 24 in the system 22, a control valve 34 for controlling the flow of urea 24 in the system 22, and a flexible, electrically heated tube 40 for supplying the urea 24 from the tank 28 to the one or more injectors 30.

With reference to FIG. 2, the heated tube 40 includes an elongate, flexible tube body 42 defining a fluid flow path 44 for the urea having a length L extending along a longitudinal axis 46. Preferably, the body 42 and the flow path 44 are cylindrical with circular cross sections. However, other shapes and cross sections may be desirable depending upon the requirements of each particular application. The body 42 is made of a suitable flexible material that is compatible with the particular fluid directed through the flow path 44, such as a suitable rubber, silicon rubber, or other polymer. Preferably, the tube body can expand 7% to 10% of its internal volume so that the tube will not break when the fluid in the flow path 44 changes to a solid state. The tube body 42 includes an electrical resistance heater, shown diagrammatically at 48, surrounding the fluid flow path 44 over the length L. The electrical resistance heater 48 has a heat output per unit length that does not vary when the tube body 42 is cut to different lengths L for different applications of the system 22 which require different lengths. As shown in FIG. 3, the electrical resistance heater 48 is formed by heat generating electric flow paths 50 that extend circumferentially in the tube body 42 around the flow path 44 to connect first and second electric power conduits 52 and 54 that are provided in the tube body 42 extending along the longitudinal axis 46 on opposite sides of the flow path 44. Suitable electrical power connectors (not shown) are provided to connect each of the conduits to an electric power supply. In this regard, the power connectors can be provided at the same end of the tube 40, at opposite ends of the tube 40, or along the length of the tube 40 depending upon the requirements of each particular application. However, it will often be preferred to provide the power connectors at the same end of the tube 40 to allow for the length L to be adjusted without having to reconfigure the power connectors.

FIG. 4 illustrates a diagrammatic modeling of the electric resistance heater 48 and the electric flow paths 50 which can be modeled with the following equations.

n=the number of flow paths 50 per unit length of tube

Rₙ=Resistance in each flow path 50

R=total resistance between conduits 52 and 54

Iₙ=current in each flow path 50

I=total current in heater 48

V=Voltage across conduits 52 and 54

W=Power

I=I₁+I₂+I₃+I₄+ . . . Iₙ

R₁=R₂=R₃=R₄= . . . =Rₙ

R=R₁/n

R=V/I

W=V²/R=I²R

In one preferred embodiment, it is desired that the heater 48 produce 17 watts for every meter in length of the tube 40. If there are 100 of the flow paths 50 for every meter of tube length and the voltage across the heater 48 is assumed to be 12 volts, the total resistance R should be 8 ohms, the single resistance Rₙ should be 800 ohms, and the current I for each meter of tube would be 1.5 amps. If the tube 40 is cut to a shorter length L, the power output will be proportional to the change in length.

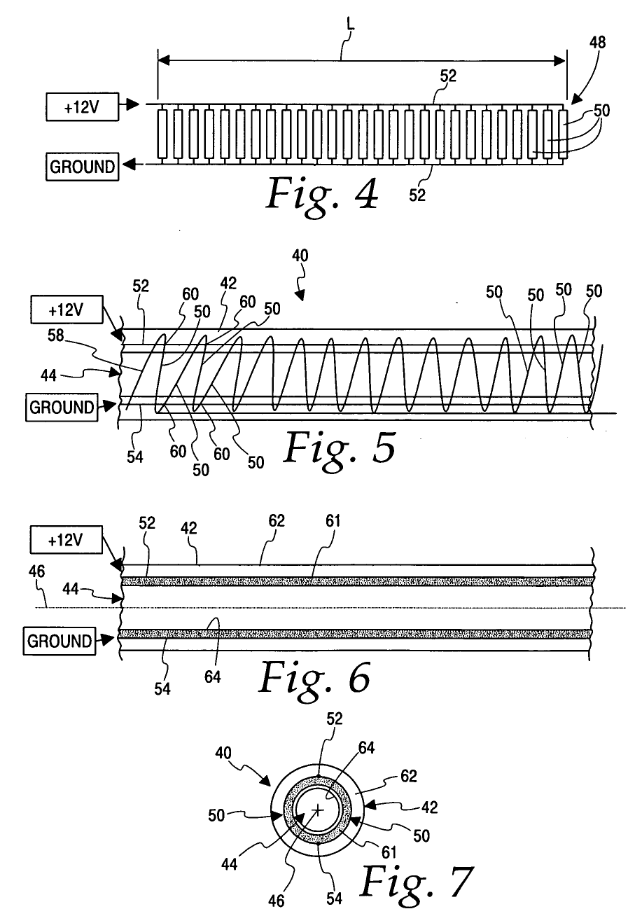

With reference to FIG. 5, in one embodiment, the heat generating electric flow paths 50 are defined by an electrical conductive wire 58 in the tube body 42 that is wrapped around the flow path 44 to engage each of the power conduits 52 and 54 at multiple points 60 along the longitudinal axis 46. This defines discrete electric flow paths 50 that are spaced along the length of the tube 40, alternating from one circumferential side to the other of the flow path 44. The power output per length of tube for any particular design will be highly dependent upon the material chosen for the resistance wire 58, the gauge of the wire 58, the wrapped diameter, and the number of wraps per unit length.

As shown in FIGS. 6 and 7, in another embodiment that is highly preferred, the heat generating electric flow paths 50 include a layer of electric conductive polymers (shown diagrammatically at 61) within the tube body 42 surrounding the flow path 44. In this regard, the entire tube body 42 can be formed from the electrically conductive polymers, or as shown in FIGS. 6 and 7, the layer 61 can be sandwiched between an outer layer 62 defining the exterior surface of the tube 40 and an inner layer 64 defining the flow path 44, with both of the layers 62 and 64 being non-electrically conductive. Suitable electrically conductive polymers are known and available commercially, with one example being the electrically conductive polymers provided by HITECH POLYMERS. In general, electrically conductive polymers can be classified as polymers with surface resistivities from 10¹ to 10⁷ ohms/square, which can be achieved by adding electrically conductive additives to the polymers, such as for example, so-called “conductive carbon additives” and carbon or stainless steel fibers. It should be appreciated that in this embodiment the flow paths 50 are not discrete flow paths that are spaced along the length of the tube 40 such as shown in FIGS. 4 and 5, but rather extend continuously over the length L and having a resistance R that can be calculated based upon a resistance per unit length multiplied times the length L of the tube 40. It should also be appreciated that this embodiment can be manufactured in an efficient manner, either by extrusion or by molding without requiring a wire wrap such as in FIG. 5. Furthermore, it is believed that this embodiment will provide a more uniform heat distribution because the flow paths 50 are continuous along the longitudinal axis, as opposed to the discrete flow paths 50 of FIGS. 4 and 5.

1. An electrically heated, flexible fluid tube comprising:
an elongate, flexible tube body defining a fluid flow path extending along a longitudinal axis;
a first electrical power conduit in the tube body extending along the longitudinal axis on one side of the flow path;
a second electrical power conduit in the tube body extending along the longitudinal axis on a side of the flow path opposite from the one side; and
heat generating electrical flow paths extending circumferentially in the tube body around the flow path and connecting the first and second power conduits to heat the flow path along the longitudinal axis.

2. The fluid tube of claim 1 wherein the heat generating electrical flow paths comprise a wire in the tube body wrapped around the fluid flow path, the wire engaging each of the power conduits at multiple points along the longitudinal axis.

3. The fluid tube of claim 1 wherein the heat generating electrical flow paths comprise electrically conductive polymers within the tube body surrounding the fluid flow path.

4. The fluid tube of claim 1 further comprising:
a first electrical connection for the first electrical power conduit at an end of the tube; and
a second electrical connection for the second electrical power conduit at an end of the tube.

5. The fluid tube of claim 4 wherein the first and second electrical connections are at the same end of the tube.

6. An electrically heated, flexible fluid tube comprising:
an elongate, flexible tube body defining a fluid flow path extending along a longitudinal axis; and
heat generating electrical flow paths extending circumferentially in the tube body around the flow path transverse to the longitudinal axis.

7. The fluid tube of claim 6 further comprising:
a first electrical power conduit in the tube body extending along the longitudinal axis on one side of the flow path; and
a second electrical power conduit in the tube body extending along the longitudinal axis on a side of the flow path opposite from the one side, the first and second electrical power conduits connected to the heat generating electrical flow paths to supply electric power thereto.

8. The fluid tube of claim 7 further comprising:
a first electrical connection for the first electrical power conduit at an end of the tube; and
a second electrical connection for the second electrical power conduit at an end of the tube.

9. The fluid tube of claim 8 wherein the first and second electrical connections are at the same end of the tube.

10. The fluid tube of claim 7 wherein the heat generating electrical flow paths comprise an electrically conductive wire in the tube body wrapped around the fluid flow path, the wire engaging each of the power conduits at multiple points along the longitudinal axis.

11. The fluid tube of claim 6 wherein the heat generating electrical flow paths comprise electrical conductive polymers within the tube body surrounding the fluid flow path.

12. An electrically heated, flexible fluid tube comprising:
an elongate, flexible tube body defining a fluid flow path having a length extending along a longitudinal axis, the tube body including an electrical resistance heater surrounding the fluid flow path over the length, the electrical resistance heater having a heat output per unit length that does not vary when the tube body is cut to different lengths.

13. The fluid tube of claim 13 further comprising:
a first electrical power conduit in the tube body extending along the longitudinal axis on one side of the flow path; and
a second electrical power conduit in the tube body extending along the longitudinal axis on a side of the flow path opposite from the one side, the first and second electrical power conduits contacting the electrical resistance heater to supply electric power thereto.

14. The fluid tube of claim 13 further comprising:
a first electrical connection for the first electrical power conduit at an end of the tube; and
a second electrical connection for the second electrical power conduit at an end of the tube.

15. The fluid tube of claim 14 wherein the first and second electrical connections are at the same end of the tube.

16. The fluid tube of claim 12 wherein the electrical resistance heater comprises electrically conductive polymers within the tube body.

17. The fluid tube of claim 16 further comprising:
a first electrical power conduit in the tube body extending along the longitudinal axis on one side of the flow path; and
a second electrical power conduit in the tube body extending along the longitudinal axis on a side of the flow path opposite from the one side, the first and second electrical power conduits contacting the electrically conductive polymers to supply electric power thereto.

18. The fluid tube of claim 12 wherein the electrical resistance heater further comprises
an electrically conductive wire in the tube body wrapped around the fluid flow path.

19. The fluid tube of claim 18 further comprising:
a first electrical power conduit in the tube body extending along the longitudinal axis on one side of the flow path; and
a second electrical power conduit in the tube body extending along the longitudinal axis on a side of the flow path opposite from the one side, the first and second electrical power conduits contacting the wire at multiple points along the longitudinal axis to supply electric power to the wire at each of the multiple points.
